(19) United States
(12) Patent Application Publication
(10) Pub. No.: US 2025/0046885 A1
(43) Pub. Date: Feb. 6, 2025

(54) LITHIUM-ION BATTERY FIRE SUPPRESSION COMPOSITION AND METHODS OF USE

(71) Applicant: Fike Corporation, Blue Springs, MO (US)

(72) Inventors: Gene Hill, Odessa, MO (US); Corry Griffin, Grain Valley, MO (US); Devang Patel, Bedfordshire (GB); Bradford T. Stilwell, Blue Springs, MO (US); Tom Farrell, Lawrence, KS (US)

(21) Appl. No.: 18/795,519

(22) Filed: Aug. 6, 2024

Related U.S. Application Data
(60) Provisional application No. 63/517,011, filed on Aug. 1, 2023.

(51) Int. Cl. H01M 10/42; H01M 10/0525

(52) U.S. Cl. CPC H01M 10/4235; H01M 10/0525; H01M 2200/10

(57) ABSTRACT

Fire suppressing agents and their use in suppressing thermal events in lithium-ion batteries are provided. The fire suppressing agents comprise an aqueous solution of a carboxylate salt, particularly a potassium or sodium salt of lactic acid, acetic acid, citric acid, glycolic acid, butyric acid, or tartaric acid. The fire suppressing agent can be delivered to a battery cell, or battery module comprising a battery cell, which is experiencing a thermal event, such as a thermal runaway, to suppress the thermal event and inhibit a cascade of the thermal event to adjacent cells.

### RELATED APPLICATION

This application claims the priority benefit of U.S. Provisional Patent Application No. 63/518,011, filed Aug. 7, 2023, which is incorporated by reference herein in its entirety.

### BACKGROUND OF THE INVENTION

### Field of the Invention

Embodiments of the present invention are directed toward fire suppressing compositions and their use in controlling thermal events in batteries, especially the suppressing and extinguishing of fires in lithium-ion batteries.

### Description of the Prior Art

Lithium-ion cells can catch fire due to a phenomenon called thermal runaway. Thermal runaway is a chain reaction process that occurs when a battery's temperature increases uncontrollably, leading to a release of energy and potentially resulting in a fire or explosion.

Cascading thermal runaway in lithium-ion batteries (which are comprised of a large number of cells) refers to a scenario where thermal runaway propagates from one cell to adjacent cells within a battery pack, leading to a widespread and uncontrolled release of energy. It occurs when the thermal runaway of a single cell triggers a chain reaction, causing neighboring cells to also undergo thermal runaway. If a single cell within a battery pack experiences thermal runaway, it can produce heat and gases that can ignite adjacent cells, leading to their thermal runaway as well. This process can continue to spread throughout the battery pack, potentially resulting in a large-scale fire or explosion.

There are several reasons why thermal runaway can occur in lithium-ion cells.

Overheating: If a lithium-ion cell is exposed to high temperatures, it can cause a breakdown of the internal components and result in a thermal runaway. Heat can be generated by external factors such as exposure to direct sunlight, hot environments, or operating the cell beyond its recommended temperature range.

Manufacturing defects: Poorly manufactured or damaged cells may have internal flaws, such as metal particles or impurities that can cause short circuits within the cell. These short circuits can lead to excessive heat generation and trigger a thermal runaway.

Overcharging or over-discharging: Charging a lithium-ion cell beyond its recommended voltage or discharging it to extremely low voltage levels can cause stress on the cell, leading to internal damage and potential thermal runaway.

Physical damage: Dropping, puncturing, or otherwise physically damaging a lithium-ion cell can cause internal components to come into contact, resulting in short circuits and heat generation.

Contamination or electrolyte leakage: If the cell's electrolyte, which is a flammable organic solvent, leaks or comes into contact with moisture or other reactive substances, it can lead to chemical reactions and heat generation.

Electrical shorting: If the exterior electrical contacts are directly shorted to each other, then excessive current draw can occur, resulting in excessive heat generation, cell deterioration, and/or thermal runaway. Note, external connections of multiple cells within a battery assembly can also be shorted by a suppression agent that is deployed to control thermal events.

### The Thermal Runaway Process

During a lithium-ion thermal runaway event, the temperature of the battery increases rapidly, leading to a self-perpetuating cycle of heat generation. This cycle can cause the battery to release flammable gases, emit smoke, and potentially explode or catch fire. The thermal runaway process typically involves several stages.

Initial Heating: The cell experiences an increase in temperature due to external factors such as overcharging, short-circuiting, mechanical damage, or exposure to high temperatures.

Exothermic Reaction: As the cell temperature rises, chemical reactions within the battery accelerate, leading to the release of heat. The heat generated further increases the battery temperature.

Gas Generation: The high temperatures cause the decomposition of electrolyte components, leading to the release of flammable gases such as hydrogen and carbon monoxide. The gas generation contributes to the increase in pressure within the cell.

Venting and Fire: At a certain temperature and pressure threshold, the cell may rupture or vent to release gases. If the released gases come into contact with an ignition source, such as a nearby flame or spark, they can ignite and result in a fire or explosion.

Cascading Thermal Runaway: The failure of one cell within a battery assembly may cause adjacent cells to fail, thereby creating a chain reaction where eventually all cells undergo thermal runaway.

It is important to note that the specific behavior of a lithium-ion cell during thermal runaway can vary depending on various factors such as cell chemistry, design, and external conditions. Battery assemblies may contain thousands of lithium-ion battery cells and cascading thermal runaway within these assemblies can burn for days.

Current products that are presently applied to lithium-ion batteries undergoing a thermal event include water, clean agents, and aerosols. Alternatively, and in some cases, the best solution is to simply let the battery burn to self-extinction.

With regard to water application, both water mist and sprinklers are applied to lithium-ion battery systems, although this mitigative approach is typically focused on room or enclosure protection and is not typically applied at the battery assembly (or module) level. Water is a good heat absorber and does a good job of cooling the fire and preventing its spread to combustible materials co-located within the same room or enclosure. Water has not, however, demonstrated the ability to stop cascading thermal runaway inside a battery module. NFPA 855 recommends sprinkler systems with a minimum density of 0.3 GPM/ft² be used in lithium-ion battery rooms.

One problem with water application is that, when used on batteries, the run-off water can become contaminated and must be properly collected and cleaned because it can be toxic to the environment. Additionally, chemically impure water (typical of municipal water) is electrically conductive and can cause electrical shorting of cells with battery assemblies, further worsening the cascaded thermal runaway.

Clean Agents, such as FK-5-1-12 and inert gasses, are used in many electrically energized applications and protect many special hazard applications. These agents work by absorbing heat at the molecular level. Unfortunately, clean agent systems do little to mitigate thermal runaway. These agents exist as gases at low temperatures and do very little to interrupt the thermal runaway event. Certain clean agents, such as FK-5-1-12, can also degrade at the extreme temperatures generated in lithium battery fires, which can liberate a combination of hydrofluoric acid gas and flammable hydrocarbons. This could create an acute toxicity and/or explosion hazard if gases are vented to occupied areas or allowed to accumulate.

With regard to aerosol application, certain aerosols contain chemical agents that can interrupt the chemical chain reactions involved in combustion. These agents can interfere with the fuel's ability to ignite or sustain a flame, thereby extinguishing the fire. However, aerosols have no significant heat capacity and will struggle to stop cascading thermal runaway.

Several battery systems operators have adopted the strategy of letting the battery self-extinguish and take few to no mitigating steps. The reason for this is that there is no proven solution for suppressing fires in lithium-ion batteries. Letting the fire burn will consume dangerous and explosive battery off-gases like hydrogen, and many of the batteries are stored at remote sites, such as near a solar or wind farm. It is important to note that operators who opt for this approach typically have battery cabinets built from expensive, highly insulated materials so they can meet the performance requirements listed in the UL 9540a standard. However, there is still a strong sentiment that the do-nothing approach is not ideal as a burning battery still does emit toxic gases that will do harm if ingested and may cause environmental damage.

Accordingly, a need exists in the art for ways of suppressing and extinguishing fires in lithium-ion batteries.

### SUMMARY OF THE INVENTION

According to one embodiment of the present invention there is provided a method of suppressing a battery fire. The method comprises applying an aqueous fire suppressing agent to a battery cell experiencing a thermal event that has resulted in or has a potential of resulting in a fire. The aqueous fire suppressing agent comprises a carboxylate salt.

According to another embodiment, a method of suppressing a battery fire within one or more battery modules is provided, with each battery module comprising a plurality of lithium-ion battery cells. The method comprises detecting a condition within the one or more battery modules associated with a battery thermal event. A flow of an aqueous fire suppressing agent is initiated into the one or more battery modules. The aqueous fire suppressing agent comprises a carboxylate salt. At least one of the plurality of battery cells located within the module is contacted with the aqueous fire suppressing agent.

According to a further embodiment, a fire suppression system is provided that comprises a fire suppressant storage tank containing a quantity of a pressurized aqueous fire suppressing agent comprising a carboxylate salt. A conduit network is connected with the fire suppressant storage tank and extends into one or more battery containers. The one or more battery containers comprises one or more battery modules. Each of the one or more battery modules comprises a plurality of battery cells. The conduit network is configured to deliver a flow of the aqueous fire suppressing agent to at least one of the one or more battery modules upon detection of a thermal event within the at least one of the one or more battery modules.

According to still another embodiment, an aqueous fire suppressing agent is provided that comprises a carboxylate salt dispersed in water. The aqueous fire suppressing agent comprises less than 0.01% by weight of a fluorosurfactant and/or a foaming agent.

According to yet another embodiment, an aqueous fire suppressing agent is provided that comprises a carboxylate salt dispersed in water. The aqueous fire suppressing agent is formulated to produce no foam upon delivery to an object on fire.

According to still a further embodiment, an aqueous fire suppressing agent is provided that consists essentially of, or consists of, water, a carboxylate salt, optionally an anti-hydrofluoric acid agent, and optionally a colorant.

### BRIEF DESCRIPTION OF THE DRAWINGS

FIG. 1 is a cutaway view of a battery container comprising a plurality of battery modules located therein and protected by a fire suppression system in accordance with an embodiment of the present invention;

FIG. 2 is a side elevation view of the battery container and fire suppression system;

FIG. 3 is a schematic side view illustration of a battery rack containing battery modules and the fire suppressing agent delivery conduit with nozzles for delivering agent to each module;

FIG. 4 is a schematic view of a battery module having a cell experiencing a thermal event resulting in the release of fire suppressing agent into the module from a storage tank; and

FIG. 5 is a chart depicting the control of a thermal event occurring in a battery module and demonstrating the arresting of thermal cascade from affected battery cells to adjacent cells within the module.

### DETAILED DESCRIPTION OF THE PREFERRED EMBODIMENT

Certain embodiments according to the present invention are directed toward fire suppressing agents that can be used to control or mitigate thermal events within batteries, especially batteries comprising lithium-ion battery cells. As used herein, the term “fire suppressing agent” means a chemical composition that is formulated to or is capable of suppressing the progression of a thermal event that, if left unchecked, has a high probability of resulting in a fire. In addition, the term “fire suppressing agent” should also be viewed as including chemical compositions that are formulated to or are capable of extinguishing an existing fire. As used herein, the term “thermal event” refers to a circumstance associated with a battery or any portion thereof in which elevated temperature conditions are experienced. The elevated temperature condition may be of internal or external origin and could lead to thermal runaway in which further increases in battery temperature are self-sustaining (i.e., without requiring the external input of heat). Thermal runaway can lead to generation of flammable gases and combustion of such gases and other materials from which the battery is comprised. Thermal runaway can also propagate from a single battery cell experiencing thermal runaway into adjacent battery cells. This phenomenon is referred to as cascading thermal runaway, and if left unchecked, can spread to all cells within a battery module. In one or more embodiments, the fire suppressing agents can suppress or stop cascading thermal runaway, i.e., the propagation of a thermal runaway experienced by one or more battery cells into one or more additional battery cells located in close proximity to the one or more cells experiencing the thermal runaway. By suppressing cascading thermal runaway, an actual or potential battery fire can be suppressed.

In one or more embodiments, the fire suppressing agents can control the temperature of one or more components making up a battery, especially a lithium-ion battery. These components include one or more battery cells, the battery case within which one or more battery cells are located and any vapor space within the battery case. In particular embodiments, when a battery is experiencing a thermal event, such as a thermal runaway within one or more battery cells making up the battery, one or more of the battery components experiences an increase in temperature. The application of the fire suppressing agent can reduce the temperature of any of these components thereby suppressing any actual or potential battery fire and suppressing cascading thermal runaway within the battery.

According to one or more embodiments, the fire suppressing agent is an aqueous or water-containing material comprising, consisting of, or consisting essentially of a carboxylate salt, particularly a C2-C6 carboxylate salt. In particular embodiments, the C2-C6 carboxylate salt comprises a lactic acid salt, an acetic acid salt, citric acid salt, a glycolic acid salt, a butyric acid salt, or a tartaric acid salt. In preferred embodiments, the C2-C6 carboxylate salt comprises a potassium or sodium lactate, acetate, citrate, glycollate, hydroxybutyrate, or tartrate, with potassium lactate being particularly preferred.

In one or more embodiments, the fire suppressing agent comprises, consists of, or consists essentially of from 30% to 80% by weight, 35% to 75% by weight, 40% to 70% by weight, or 45% to 65% by weight, and most preferably about 60% by weight of the carboxylate salt dispersed in water. Accordingly, the water component can make up from 20% to 70% by weight, from 25% to 65% by weight, from 30% to 60% by weight, from 35% to 55% by weight, or about 40% by weight of the fire suppressing agent.

The fire suppressing agent may further comprise, consist of, or consist essentially of one or more optional components that impart beneficial characteristics to the agent. These optional components include an anti-hydrofluoric acid agent and a colorant. In one or more embodiments, the anti-hydrofluoric acid agent is a compound or mixture of compounds that in some manner counteracts the harmful effects of fluorine and/or fluorine compounds that can be liberated during a battery thermal event, and in particular a battery fire. Fluorine-containing materials are often associated with batteries, especially the electrolyte used in lithium-ion batteries. In fact, the most commonly used electrolyte for lithium-ion batteries is LiPF₆. As a part of a thermal event, the fluorine-containing electrolyte can react with other components to generate a fluorine-containing gas, such as hydrogen fluoride (HF) (hydrofluoric acid gas). The anti-hydrofluoric acid agent can operate to impede the reactions from which HF is formed, react with HF gas to form less toxic substances, and/or absorb or adsorb HF gas that is generated so that it is not released to the environment surrounding the battery.

Exemplary anti-hydrofluoric acid agents that can be used with embodiments of the present invention include one or more members selected from the group consisting of citronella oil (or components thereof including citronellal, citronellol, and geraniol), d-limonene, dipentene, p-cumene, β-pinene, oleic acid, and vitamin E. Citronella oil, or its components, and d-limonene are particularly preferred anti-hydrofluoric acid agents. The fire suppressing agent can contain from 0.01% to 2% by weight, 0.05% to 1.5% by weight, from 0.1% to 1% by weight, from 0.2% to 0.8%, from 0.3% to 0.6% or about 0.475% by weight of the anti-hydrofluoric agent.

The addition of a colorant can change the spectral emissivity (and hence, the absorptivity) of the fire suppressing agent, thereby enhancing the agent's ability to absorb thermal radiation emitting from a battery cell undergoing thermal runaway (and absorb thermal radiation that would otherwise be absorbed by another cell within the battery assembly/module). In certain embodiments, the colorant is a pigment or dye, with dyes being particularly preferred due to their ability to their solubility in water. In one or more embodiments, the fire suppressing agent can contain from 0.01% to 1% by weight, from 0.05% to 0.5% by weight, from 0.1% to 0.25% by weight, or about 0.125% by weight of the colorant.

In one or more embodiments, the colorant absorbs light in the wavelength range of 500 to 750 nm, 550 to 700 nm, or 600 to 650 nm. In particular embodiments, the colorant causes the fire suppressing agent to assume a blue color.

In one or more embodiments, the fire suppressing agent produces low quantities of foam or substantially no foam upon delivery to a target object (i.e., an object on fire) area experiencing a thermal event. In this regard, the fire suppressing agent, when placed inside a container, such as a graduated cylinder or other tube, and air introduced or the container shaken produces little to no foam. In one particular embodiment, 50 mL of the fire suppressing agent can be placed into a graduated cylinder and air bubbles are introduced, such that through a diffuser or sparger, at a flow rate of 1 L/min little to no foam is produced, or if foam is produced, the volume of foam produced completely collapses within 2 minutes, 1 minute, or 30 seconds. In further embodiments, the fire suppressing agent comprises, consists of, or consists essentially of less than 0.1%, less than 0.01%, or less than 0.001%, by weight of a fluorosurfactant and/or a foaming agent. Preferably, the fire suppressing agent is essentially free of all surfactants, including hydrocarbon surfactants, fluorosurfactants, and foaming agents. In particular, embodiments of the fire suppressing agents do not contain or contain only minute quantities of fluorosurfactant such as an amphoteric perfluoroalkyl surfactants, especially that which comprises a 27% active solution RFCH₂CH₂SO₂NHCH₂CH₂CH₂N+(CH₃)₂CH₂COO⁻. Also in particular embodiments, the fire suppressing agents do not contain or contain only minute quantities of foam boosters (or foaming agents) such as diethylene glycol monobutyl ether. Also in particular embodiments, the fire suppressing agents do not contain or contain only minute quantities of nonionic alkyl polyglycoside surfactants, such as alkyl polyglycosides based on synthetic fatty (C9-C11) alcohols.

In one or more embodiments, the fire suppressing agent is relatively shelf stable in that it does not precipitate or sediment for extended periods of time. In certain embodiments, the fire suppressing agent can be stored for periods of at least 3 months, at least 6 months, at least 12 months, at least 1 year, or at least 5 years at 25° C. without formation of precipitates or sediment.

In one or more embodiments, the fire suppressing agent exhibits low electrical conductivity. This feature prevents the fire suppressing agent from causing or contributing to electrical shorts within the battery module to which the agent is applied. Particularly, the fire suppressing agent exhibits a conductance of less than 1,500, less than 800, less than 500, less than 250 or less than 100 microsiemens per centimeter (μS/cm). In alternate embodiments, the fire suppressing agent exhibits a conductance of from 0.5 to 1,000 μS/cm, from 3 to 800 μS/cm, or from 10 to 500 μS/cm.

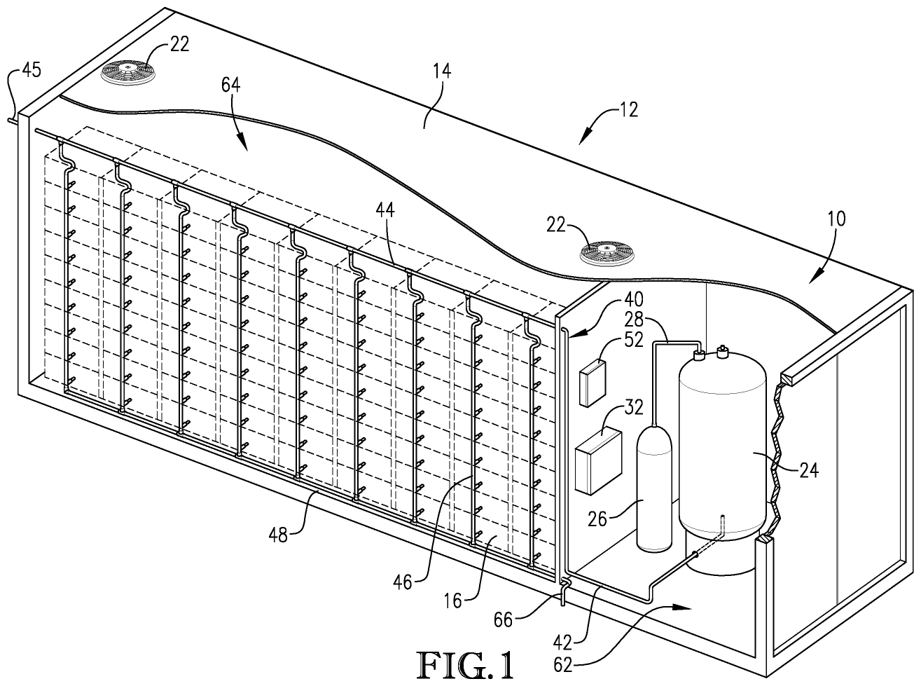

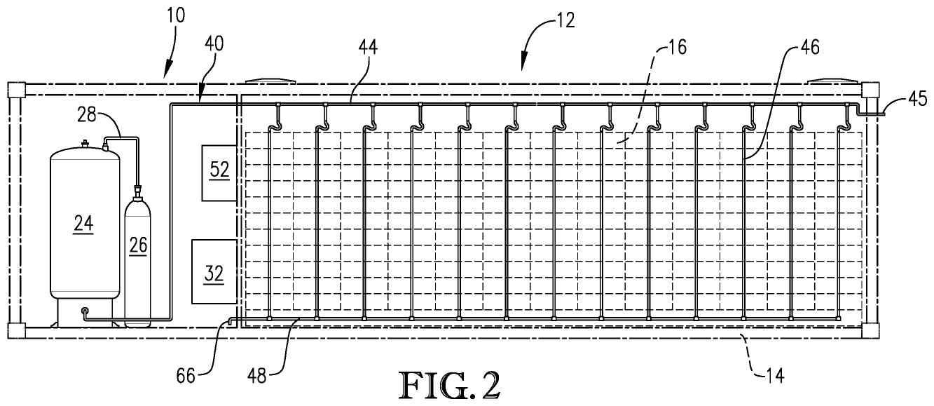

The fire suppressing agents as described herein can be used in fire suppressing systems, particularly for use in conjunction with battery containers and assemblies. Turning to FIGS. 1 and 2, a fire suppression system 10 for protecting a battery container 12 is shown. In one or more embodiments, the battery container 12 may comprise an enclosed structure 14 inside of which a plurality of battery modules 16 are located. Enclosed structure 14 may be any suitable enclosure, such as a stand-alone building, a room within a building, and a mobile container (e.g., a shipping container).

The battery container 12 includes one or more fans 22 installed therein. One function of fans 22 is to provide ventilation within battery container 12. In particular, fans 22 are configured to withdraw vapors or gases from within the enclosed structure 14 and direct them to a location outside of the enclosed structure. The placement of fans 22 as depicted in FIG. 1 is merely exemplary and other designs and configurations are possible without departing from the scope of the present invention. In addition, duct work, not shown, can be provided to direct the gases to a safe venting location.

Fire suppression system 10 comprises at least one fire suppressant storage tank 24 and, optionally, at least one propellant tank 26 that is connected to storage tank 24 via conduit 28. It is noted that conduit 28 is only illustrated schematically and that various controls and valves may be present as needed, especially if multiple tanks 24 and/or 28 are present. The fire suppressant storage tank 24 is configured to store an amount of the fire suppressant agent, under pressure supplied by a pressurized gas from propellant tank 26, that is sufficient to provide a flow of water to one or more portions of the enclosed structure 14. The pressurized gas within propellant tank 26 is preferably an inert gas, such as nitrogen or carbon dioxide; however, any inert gas that is without a component that could serve as an oxidizing agent for a fire, especially a battery fire, can be used. In certain embodiments, it is noted that propellant tank 26 may not be required if storage tank 24 is configured to hold a sufficient quantity of the fire suppressing agent and propellant.

In one or more embodiments, fire suppressant storage tank 24 and propellant tank 26 are located within a first compartment 62 of container 12 that is separate from a second compartment 64 in which the battery modules 16 are located. Alternatively, storage tank 24 and propellant tank 26 can be located within an enclosure (not shown) that is entirely separate from and external to battery container 12. A climate control unit 32 may be installed within compartment 62 to provide heating or cooling as needed to maintain a desired operational temperature within the compartment.

Fire suppression system 10 also comprises a controller 52 that is coupled to the fire suppressant storage tank 24. The controller 52 is also connected with the one or more fans 22 located in battery container 12 and configured to actuate fans 22 upon receiving a signal representing an operational condition associated with the storage tank 24. Controller 52 may comprise an addressable or conventional control panel, such as a digital, peer-to-peer, bi-directional communication system available under the name CHEETAH Xi by Fike Corporation, Blue Springs, Missouri.

In certain embodiments, controller 52 comprises additional functionality beyond detecting fire suppressant storage tank operational conditions and fan control. For example, the controller 52 can use various technologies to detect smoke, flame, or off gases generated by batteries experiencing a thermal event. Smoke detection can be achieved through the use of photo-electric smoke detectors, or air sampling smoke detectors, such as the VESDA detectors by Xtralis. Thermal or heat detection can be achieved through monitoring of the sprinkler heads, use of heat detectors, linear heat detection cables, fiber optic linear heat detection cables, and thermal video analytic imaging. Gas detection can be achieved through the use of stand-alone gas detectors such as hydrogen detectors (available from Honeywell Analytics), in rack gas detection (LI-ION TAMER by Xtralis), and smoke detectors with in-line XCL gas sensor for hydrogen or carbon monoxide detection (available from Xtralis). Controller 52 can also provide integration to building management systems or a programable logic controller (PLC) via gateway to provide messaging from the fire panel. Controller 52 can also be configured to shut down charging circuits of batteries upon detection of a thermal event. Controller 52 can be configured to provide communication with a central station or facility manager via a communicator and/or computer graphics workstation. Controller 52 can also activate local notification systems such as horns, bells, and strobes.

The fire suppressant storage tank 24 is connected to a conduit network 40 that extends into battery container 12. The conduit network 40 generally comprises one or more supply pipes 42 that connect the fire suppressant storage tank 24 with a distribution header 44 located within the battery container 12. The distribution header 44 may be equipped with an outlet section 45 for coupling of the network with headers located in additional battery containers. A plurality of fire suppressant delivery pipes 46 extend from header 44 and connect header 44 with a collector pipe 48. Collector pipe 48 may comprise an outlet 66, equipped with a valve (not shown) to permit bleeding of the conduit network 40, as necessary. As depicted in the Figures, one fire suppressant delivery pipe 46 is provided for each rack assembly 18, although it is within the scope of the present invention for conduit network 40 to be configured differently.

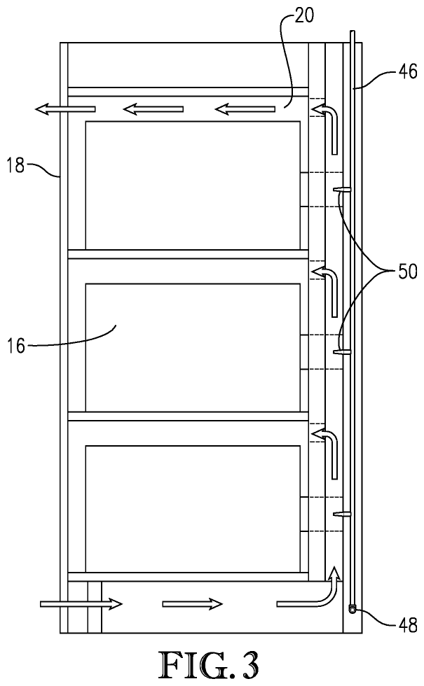

As can be seen in FIG. 3, each delivery pipe 46 comprises a plurality of nozzles or heads 50 distributed along the length thereof. In one or more embodiments, at least one nozzle 50 is provided for each battery module located within rack assembly 18, although this need not always be the case depending upon how rack assembly 18 is configured. Nozzles 50 may comprise any kind of fire suppression system nozzle or head known to those in the art. However, in one or more embodiments, the nozzles 50 are passive and do not require input of any other sensor or device in order to activate. Exemplary nozzles 50 include those comprising a heat-sensitive element, such as a glass bulb or fusible link, which breaks or is sufficiently distorted upon exposure to elevated temperature conditions, typically between 70-95° C., which then permits water to flow through the nozzle. Thus, nozzles 50 may be configured to release a flow of water upon exposure to a nearby elevated temperature condition that is associated with a thermal event occurring within a battery module 16.

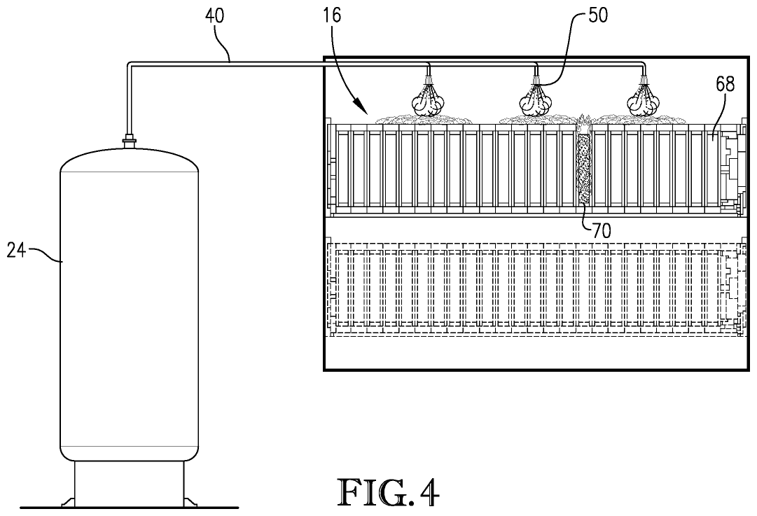

The operation of a fire suppressing system in methods of suppressing a battery fire, particularly within one or more battery modules, each comprising a plurality of lithium-ion battery cells, is described below. With particular reference to FIGS. 3 and 4, an exemplary battery rack assembly 18 comprising a plurality of battery modules 16 installed therein. The rack assembly 18 can be configured with ducts or channels 20 to facilitate cooling or venting of the battery modules 16 as indicated by the arrows. Each battery module 16 comprises a plurality of individual battery cells 68 stacked together. The battery cells can be of any chemistry (preferably lithium ion) or configuration, such as cylindrical or prismatic.

The fire suppressing agents and fire suppressing systems described herein are operable to suppress a fire, especially a battery fire located within one or more battery modules comprising a plurality of battery cells. Exemplary battery modules 16 are depicted in the Figures and described above. However, in its broadest sense, as used here, a battery module is simply a collection of individual battery cells. Most commonly, the cells within the module are electrically connected together such as through a common busbar or similar structure, but this need not always be the case.

One or more embodiments of the present invention are particularly focused on addressing the problem of cascading thermal runaway in which a thermal event occurring in one battery cell initiates a thermal event in one or more adjacent battery cells. Thus, in certain embodiments, the methods described herein seek not only to retard or stop the cascading effect of a battery thermal event, but also to extinguish or suppress the initial thermal event occurring within the battery module. For the sake of brevity, the terms “suppress” or “suppressing” refers to both the acts of controlling a thermal event from reaching a point of self-heating, which is highly likely of turning into a fire, or extinguishing an active fire.

Methods according to one or more embodiments include a detection step in which a condition within the one or more battery modules associated with a battery thermal event are sensed or detected. As described above, any kind of sensor commonly used in fire detection and suppression systems, such as thermal sensors, light sensors, video analytic imaging, and gas detectors, can be used. Such sensors can be active or passive. The conditions associated with a thermal event include identification of an increase in temperature within a battery module or battery cell of greater than 30° C. in less than 500 seconds, greater than 50° C. in less than 500 seconds, greater than 75° C. in less than 500 seconds, or greater than 100° C. in less than 500 seconds. The rate of increase in battery temperature can also occur much more rapidly in that the foregoing temperature rises can be encountered in less than 250 seconds, less than 100 seconds, or less than 60 seconds. Other conditions to be detected can include the reaching of a certain predetermined temperature threshold, the detection of battery cell off gases such as hydrogen or carbon monoxide, detection of visible or infrared light, or smoke given off by the thermal event.

With reference to FIG. 4, upon detection of the existence of a thermal event that has become an active fire or has the potential or strong likelihood of becoming an active fire, a flow of a fire suppressing agent as described herein is initiated and directed into the affected battery module(s). The initiation of the flow of fire suppressing agent can also be an active or passive event. In an active initiation of flow situation, a controller can, based upon the receipt of a signal from a detector, initiate a release of pressurized fire suppressing agent from fire suppressant storage tank 24 and into piping network 40 that terminates within the interior of the battery module(s) 16. Once introduced into piping network 40, the fire suppressing agent can be released into the battery module(s) 16 via nozzles 50. The release of fire suppressing agent from nozzles 50 can occur automatically upon initiation of the flow of fire suppressing agent from tank 24, or nozzles 50 can comprise thermally activated agent delivery devices that include a heat-sensitive element, such as a glass bulb or fusible link, that breaks or is sufficiently distorted upon exposure to elevated temperature conditions, typically between 70-95° C. resulting from the thermal event, to permit the fire suppressing agent to flow therethrough.

As an alternative, piping network 40 can be preloaded with the aqueous fire suppressing agent supplied from storage tank 24 prior to the detection of a condition within the one or more battery modules 16 associated with a battery thermal event. Piping network 40 terminates within the battery module 16 at one or more thermally activated agent delivery devices 50. Heat generated by the thermal event results in opening of the devices 50 to release a flow of the fire suppressing agent into the battery module 16.

Once inside the battery module 16, the fire suppressing agent contacts at least one of the plurality of battery cells 68, and in particular, the battery cell 70 that is undergoing a thermal event. During the contacting step, the liquid fire suppressing agent contacts the battery cell 70 experiencing the thermal event. In addition, it is preferable for adjacent battery cells 68 to also be contacted with the fire suppressing agent. In one or more embodiments, the contacting step comprises flooding the battery module 16 with the fire suppressing agent. The act of flooding the battery module 16 can include completely immersing one or more battery cells 68, 70 contained within module 16 in the fire suppressing agent. In such embodiments, gases, such as battery off gases and ambient oxygen, are displaced from the interior volume of the module 16, thus serving to further control progression of the thermal event or prevent an explosion within the module. The liquid fire suppressing agent generally comprises a high thermal capacity and a high boiling point, which helps to absorb the heat generated by the failing battery cell 70 and reduce the amount of heat delivered to adjacent cells.

### EXAMPLE

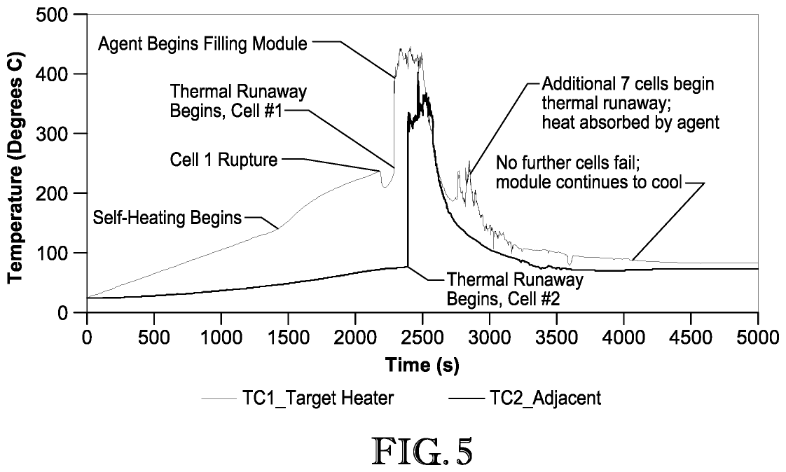

In this Example, the efficacy of controlling a thermal event in a lithium-ion battery module comprising 36 lithium-ion pouch battery cells using a potassium lactate-containing fire suppressing agent in accordance with the present invention was investigated. A cylinder was loaded with 375 lbs. of a fire suppressing composition comprising 60% by weight potassium lactate and 40% water. The tank was connected to a suppressant delivery system that had outlets terminating inside the battery module. An external heating device was used to heat one cell within the battery module. As can be seen in FIG. 5, cell number 1 was heated using the external heater. About 1500 seconds after heating began, and at a temperature of about 150° C., the battery cell began to self-heat. About 600 seconds later, cell number 1 ruptured and a thermal runaway reaction began shortly thereafter, at which time the fire suppressing agent was introduced into the battery module.

Approximately 200 seconds after the rupture of cell number 1, and approximately 100 seconds after the flooding of the battery module began, an adjacent cell number 2 experienced a thermal runaway. However, as can be seen, the heat from the thermal runaway events of cells 1 and 2 quickly subsided following deployment of the fire suppressing agent. As the temperature dropped, an additional 7 cells experienced a thermal runaway. However, only mild temperature spikes were encountered as a part of these runaway events indicating that the heat from these runaway events was readily absorbed by the fire suppressing agent. The temperature within the battery module continued to drop cooling below the threshold for self-heating without failure of any additional cells. Thus, the thermal cascade was suppressed spread to the remaining cells within the module was effectively prevented.

We claim:

1. A method of suppressing a battery fire comprising applying an aqueous fire suppressing agent to a battery cell experiencing a thermal event that has resulted in or has a potential of resulting in a fire, the aqueous fire suppressing agent comprising a carboxylate salt.

2. The method of claim 1, wherein the carboxylate salt comprises a potassium or sodium salt of lactic acid, acetic acid, citric acid, glycolic acid, butyric acid, or tartaric acid.

3. The method of claim 1, wherein the aqueous fire suppressing agent comprises from 30% to 80% by weight of the carboxylate salt.

4. The method of claim 1, wherein the aqueous fire suppressing agent comprises from 20% to 70% by weight water.

5. The method of claim 1, wherein the aqueous fire suppressing agent comprises an anti-hydrofluoric acid agent and/or a colorant.

6. The method of claim 5, wherein the anti-hydrofluoric acid agent comprises one or more members selected from the group consisting of citronella oil, d-limonene, dipentene, p-cumene, β-pinene, oleic acid, and vitamin E.

7. The method of claim 5, wherein aqueous fire suppressing agent comprises from 0.01% to 2% by weight of the anti-hydrofluoric acid agent, and/or from 0.01% to 1% by weight of the colorant.

8. The method of claim 5, wherein the aqueous fire suppressing agent consists essentially of water, the carboxylate salt, optionally an anti-hydrofluoric acid agent, and optionally a colorant.

9. The method of claim 1, wherein the battery cell comprises a lithium-ion battery cell.

10. The method of claim 1, wherein the thermal event is a fire.

11. The method of claim 1, wherein the thermal event is an increase in battery temperature of greater than 30° C. in less than 500 seconds.

12. The method of claim 1, wherein the applying of the aqueous fire suppressing agent to the battery cell comprises flooding the battery cell with the aqueous fire suppressing agent.

13. A method of suppressing a battery fire within one or more battery modules, each battery module comprising a plurality of lithium-ion battery cells, the method comprising:
detecting a condition within the one or more battery modules associated with a battery thermal event;
initiating a flow of an aqueous fire suppressing agent into the one or more battery modules, the aqueous fire suppressing agent comprising a carboxylate salt; and
contacting at least one of the plurality of battery cells located within the module with the aqueous fire suppressing agent.

14. The method of claim 13, wherein the detecting step comprises detecting off gases, smoke, light, or heat resulting from the battery thermal event, wherein the aqueous fire suppressing agent is contained within a storage vessel, and upon detection of the smoke, light, or heat resulting from the thermal event, the aqueous fire suppressing agent is flowed from the storage vessel and into a piping network that is coupled to the one or more battery modules, wherein the piping network comprises one or more thermally activated agent delivery devices configured to deliver the aqueous fire suppressing agent from the piping network into the one or more battery modules, wherein heat from the thermal event actuates the one or more thermally activated agent delivery devices thereby resulting in the initiation of the flow of the aqueous fire suppressing agent into the one or more battery modules.

15. The method of claim 13, wherein the aqueous fire suppressing agent is contained within a storage vessel that is operably connected to a piping network, the piping network terminating within the interior of the one or more battery modules at one or more thermally activated agent delivery devices, wherein the piping network is preloaded with the aqueous fire suppressing agent prior to the detection of the condition within the one or more battery modules associated with the battery thermal event, wherein heat from the battery thermal event actuates the one or more thermally activated agent delivery devices thereby resulting in the initiation of the flow of the aqueous fire suppressing agent into the one or more battery modules.

16. The method of claim 13, wherein the contacting step comprises flooding the one or more battery modules with the aqueous fire suppressing agent.

17. The method of claim 13, wherein the flooding of the one or more battery modules displaces substantially all of the gas contained within the battery module.

18. The method of claim 13, wherein the aqueous fire suppressing agent comprises from 30% to 80% by weight of the carboxylate salt and from 20% to 70% by weight water, wherein the carboxylate salt comprises a potassium or sodium salt of lactic acid, acetic acid, citric acid, glycolic acid, butyric acid, or tartaric acid.

19. The method of claim 13, wherein the aqueous fire suppressing agent comprises from 0.01% to 2% by weight of an anti-hydrofluoric acid agent and/or from 0.01% to 1% by weight of a colorant.

20. The method of claim 19, wherein the anti-hydrofluoric acid agent comprises one or more members selected from the group consisting of citronella oil or one or more components thereof, d-limonene, dipentene, p-cumene, β-pinene, oleic acid, and vitamin E.

21. A fire suppression system comprising:
a fire suppressant storage tank containing a quantity of a pressurized aqueous fire suppressing agent comprising a carboxylate salt; and
a conduit network connected with the fire suppressant storage tank and extending into one or more battery containers, the one or more battery containers comprising one or more battery modules, each of the one or more battery modules comprising a plurality of battery cells,
the conduit network being configured to deliver a flow of the aqueous fire suppressing agent to at least one of the one or more battery modules upon detection of a thermal event within the at least one of the one or more battery modules.

22. The fire suppression system of claim 21, wherein the aqueous fire suppressing agent comprises from 30% to 80% by weight of the carboxylate salt and from 20% to 70% by weight water, wherein the carboxylate salt comprises a potassium or sodium salt of lactic acid, acetic acid, citric acid, glycolic acid, butyric acid, or tartaric acid.

23. The fire suppression system of claim 21, wherein the aqueous fire suppressing agent comprises from 0.01% to 2% by weight of an anti-hydrofluoric acid agent and/or from 0.01% to 1% by weight of a colorant, wherein the anti-hydrofluoric acid agent comprises one or more members selected from the group consisting of citronella oil or one or more components thereof, d-limonene, dipentene, p-cumene, β-pinene, oleic acid, and vitamin E.

24. An aqueous fire suppressing agent comprising a carboxylate salt dispersed in water, the aqueous fire suppressing agent comprising less than 0.01% by weight of a fluorosurfactant and/or a foaming agent.

25. An aqueous fire suppressing agent comprising a carboxylate salt dispersed in water, the aqueous fire suppressing agent being formulated to produce no foam upon delivery to an object on fire.

26. The aqueous fire suppressing agent of claim 25, wherein the aqueous fire suppressing agent comprises from 30% to 80% by weight of the carboxylate salt and from 20% to 70% by weight water, wherein the carboxylate salt comprises a potassium or sodium salt of lactic acid, acetic acid, citric acid, glycolic acid, butyric acid, or tartaric acid.

27. The aqueous fire suppressing agent of claim 25, wherein the aqueous fire suppressing agent comprises from 0.01% to 2% by weight of an anti-hydrofluoric acid agent and/or from 0.01% to 1% by weight of a colorant, wherein the anti-hydrofluoric acid agent comprises one or more members selected from the group consisting of citronella oil or one or more components thereof, d-limonene, dipentene, p-cumene, β-pinene, oleic acid, and vitamin E.

28. The aqueous fire suppressing agent of claim 25, wherein the aqueous fire suppressing agent is essentially free of surfactants.

29. An aqueous fire suppressing agent consisting essentially of water, a carboxylate salt, optionally an anti-hydrofluoric acid agent, and optionally a colorant.
